(19) United States
(12) Patent Application Publication
(10) Pub. No.: US 2020/0079503 A1
(43) Pub. Date: Mar. 12, 2020

(54) Folding Multi-rotor Vertical Takeoff and Landing Aircraft

(71) Applicant: Stephen Lee Bailey, Los Gatos, CA (US)

(72) Inventor: Stephen Lee Bailey, Los Gatos, CA (US)

(21) Appl. No.: 16/550,682

(22) Filed: Aug. 26, 2019

Related U.S. Application Data
(60) Provisional application No. 62/729,086, filed on Sep. 10, 2018.

(51) Int. Cl. B64C 29/00; B64C 11/00; B64C 9/04; B64C 25/36; B64C 23/06; B64C 1/00

(52) U.S. Cl. CPC B64C 29/0033; B64C 11/001; B64C 9/04; B64C 25/42; B64C 23/069; B64C 1/0009; B64C 25/36

(57) ABSTRACT

A folding multi-rotor VTOL aircraft is described that stows the rotor propulsion system in the region above the fuselage and fit within the length and width of the fuselage footprint. The folding members supporting the rotor propulsion units then fit within the regions between the stowed rotor diameters. The members are of sufficient length that when unfolded to operational configuration the slipstream of the rotors do not impinge on the fuselage. Overall aircraft height includes the fuselage, the stowed rotors, and a powered landing gear that provides ground mobility and short take-off and emergency landing capabilities. The overall height is minimized by a compact rotor system and low or adjustable landing gear ground clearance. The rotor propulsion units may incorporate ducts that are specially designed to produce improved lift.

### CROSS-REFERENCE TO RELATED APPLICATIONS

This application claims the benefit of provisional patent application 62/729,086 filed 2018, Sep. 10 by the present inventor.

Federally Sponsored Research: None.

Sequence Listing: None.

### BACKGROUND

A multi-rotor copter is a Vertical Takeoff and Landing (VTOL) aerial vehicle consisting of a fuselage body surrounded by independent rotor propulsion units mounted on the vertical axis. By varying the distribution of speed and power of the rotors, vertical liftoff and forward controlled flight is possible. A further refinement of the multi-rotor copter is the capability to tilt the propulsors to produce more thrust in the forward direction with less pitch angle on the fuselage during cruise. The number of rotors can vary and thus there are tricopters, quadcopters, hexacopters, octocopter, etc. The multi-rotor aircraft has been applied from very small drones that fit into the hand to large versions capable of transporting people.

The rotor propulsion units can take the form of a single open propeller, counter-rotating propellers, ducted single propeller, ducted counter-rotating propellers, etc. depending on the design requirements. It is generally held that larger diameter rotors turning at lower speed are more efficient than smaller diameter rotors turning at higher speeds and that ducted or shrouded propellers generate greater thrust at lower speeds but generate greater drag at higher speeds. It is also generally acknowledged that properly designed ducted, or shrouded as it may be termed, propellers can be quieter, safer, with less propeller tip losses due to the surrounding duct. It is also known that the duct can generate lift in a manner similar to a circular wing.

Regardless of the size of the multi-rotor aircraft it is generally considered a desireable feature that the unit is able to fold the rotor propulsion units into a smaller stowage arrangement. The smaller drone size unit is able to fit into a smaller transport container. The passenger carrying version might fit into a garage or allow more units to be stored around a launch pad area while charging batteries or fueling. The current state-of-art in multi-rotor aircraft consists of numerous methods for folding the rotors relative to the fuselage to reduce the size, but in no case does the folded arrangement fit completely within the footprint (projected length and width) of the fuselage. This capability is critical if the drone or aircraft is intented to better fit within the confines of a handheld carton, transport iso-container, home garage, or other constraint while providing a fuselage of desireable floorplan and volume.

### SUMMARY

According to one aspect of the present invention there is provided an aerial vehicle including a fuselage for containing useful payload and propelled by multiple (two or more) rotors that are stowed within the footprint of the fuselage.

According to a further aspect of the present invention the individual rotor propulsion modules are of diameter equal to or less than the fuselage width and arranged collectively in substantial aligment with a combined length less than the length of the fuselage; thereby, fitting within the footprint of the fuselage.

According to a further aspect of the present invention the individual rotor propulsion modules are connected to the fuselage with vertical and horizontal support members that are connected to the fuselage in the regions between the stowed rotor diameters.

According to a further aspect of the present invention the individual rotor propulsion units deploy in an arc about the vertical support member pivot bearing until deployed outboard of the fuselage profile.

In certain embodiments, the aerial vehicle operates in this configuration as a horizontal rotor, multi-rotor copter.

In certain embodiments, the rotor propulsion units of the aerial vehicle then rotate about the horizontal axis to operate as a tilt-rotor copter.

In certain embodiments, the rotor propulsion units of the aerial vehicle are surrounded by a nacelle to form a ducted, or shrouded, propulsion unit.

In certain embodiments, the duct or shroud nacelle is shaped of varying cross-sections about its circumference in a manner for improved aerodynamic lift and drag.

In certain embodiments, the fuselage contains a landing gear in combination of independently operating powered and castered wheels to provide ground mobility and for the tilt-rotor copter embodiment short take-off and emergency landing capability while fitting within the fuselage footprint and while minimizing the impact on overall stowage height.

### DESCRIPTION OF DRAWINGS

The invention is described below in greater detail with reference to the accompanying drawings which illustrate embodiments of the invention, and wherein:

FIG. 1 is a Top View of an Embodiment of a Folding Multi-rotor Vertical Take-off and Landing (VTOL) Aircraft with Stowed Ducted Rotor Propulsion Units.

FIG. 2 is a Perspective View of an Embodiment of a Folding Multi-rotor VTOL Aircraft with Stowed Ducted Rotor Propulsion Units

FIG. 3 is a Perspective View of an Embodiment of a Folding Multi-rotor VTOL Aircraft with Stowed Open Rotor Propulsion Units.

FIG. 4 is a Perspective View of an Embodiment of a Folding Multi-rotor VTOL Aircraft with Deployed Open Rotor Propulsion Units.

FIG. 5 is a Top View of an Embodiment of a Folding Multi-rotor VTOL Aircraft with Deployed Open Rotor Propulsion Units

FIG. 6 is a Perspective View of an Embodiment of a Folding Multi-rotor VTOL Aircraft with Deployed Ducted Rotor Propulsion Units in Take-off or Landing Modes

FIG. 7 is a Perspective View of an Embodiment of a Folding Multi-rotor VTOL Aircraft with Tilted Ducted Rotor Propulsion Units in Flight Mode

FIG. 8 is a Perspective View of an Embodiment of a Rotor Propulsion Unit Duct with Circumferentially Varying Cross-Sectional Shapes

FIG. 9 is a Perspective View of Embodiment of a Folding Multi-rotor VTOL Aircraft with Tilted Ducted Rotor Propulsion Units with Duct Winglets

FIG. 10 is a Perspective View from the Rear of an Embodiment of a Folding Multi-rotor VTOL Aircraft with Tilted Ducted Rotor Propulsion Units with Duct Exit Lift Slats

### REFERENCE NUMERALS

10 folding multi-rotor vertical take-off and landing aircraft

20 rotor propulsion units

30 fuselage

40 duct

50 vertical support member

60 vertical support member pivot bearing

70 propulsion foundation

80 horizontal support member

90 horizontal support member pivot bearing

100 power wheels

110 caster wheels

120 duct winglets

130 duct exit lift slats

A fuselage footprint

B top duct cross-section

C side duct cross-sections

D bottom duct cross-section

E duct inside cylindrical surface E

### DESCRIPTION

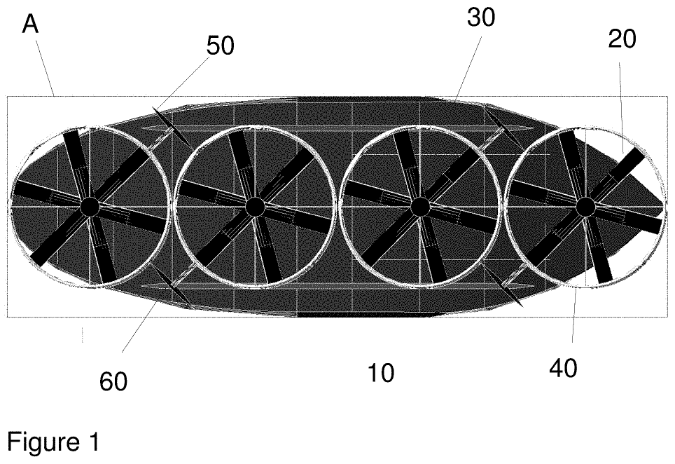

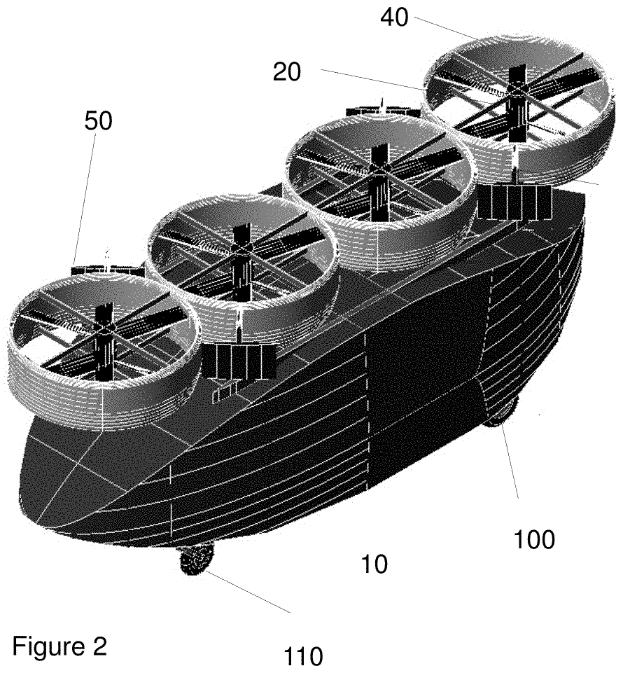

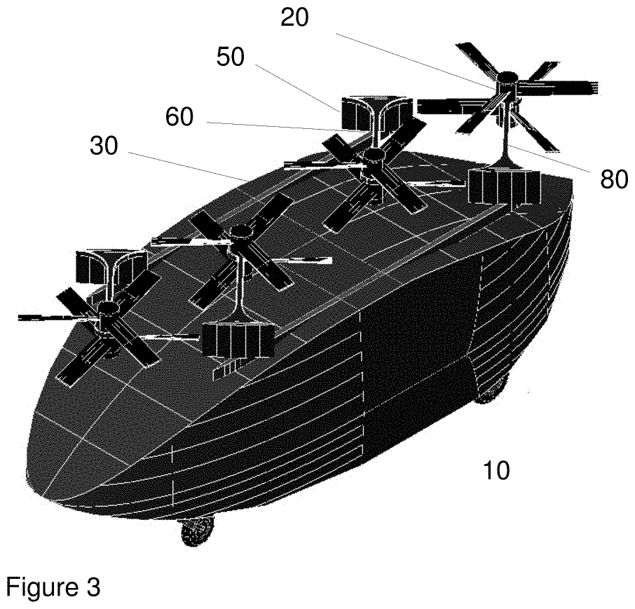

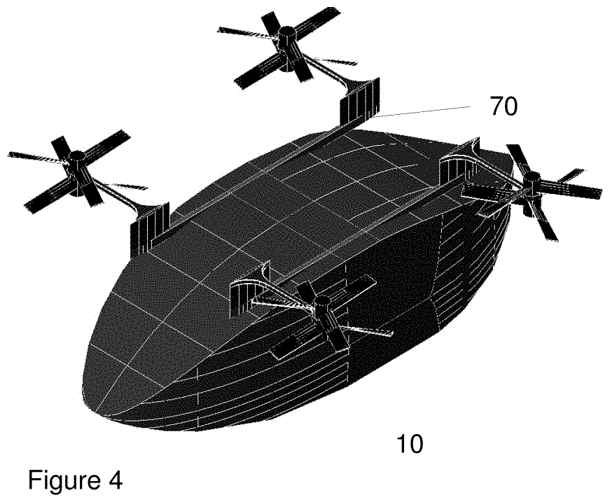

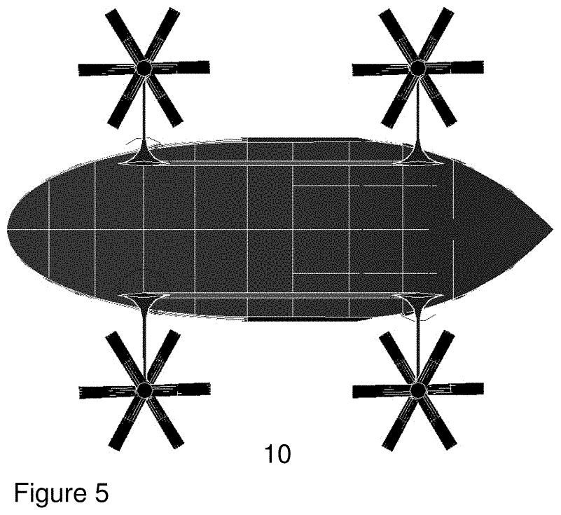

A folding multi-rotor vertical takeoff and landing (VTOL) aircraft 10 is described that provides a compact stowage arrangement on the ground whereby the stowed rotor propulsion units 20 fit within the length and width (footprint A) of the fuselage 30, as is illustrated in FIG. 1. The rotor propulsion units 20, whether with a duct 40 as illustrated in FIG. 2 or open rotor as illustrated in FIG. 3, unfold in a substantially horizontal plane into an operating position by rotation of a vertical support member 50 about a vertical support pivot bearing 60. The slipstream of said unfolded rotor propulsion units 20 is clear of said fuselage 30 to enable VTOL flight as a multi-rotor copter as illustrated in FIG. 4 and FIG. 5. Said vertical support member pivot bearing 60 may be mounted directly onto said fuselage 30 or through a propulsion foundation mount 70. Said rotor propulsive units 20 are in the preferred embodiment of an overall diameter less than the width of said fuselage 30. Said rotor propulsive units 20 are of any quantity required for propulsive flight, but are typically provided in pairs to provided balanced flight, and in the preferred embodiment total in substantially side-by-side length less than that of said fuselage 30. The horizontal support members 80 supporting said rotor propulsion units 20 are sufficiently short in length to enable said vertical support member 50 to be mounted within the open spaces between stowed rotor propulsion units 20 while also remaining within the width of said fuselage 30 footprint A. If the total thrust produced by said rotor propulsion units 20 is insufficient given the maximum swept diameter, then multiple rotor blade sets may be designed within said rotor propulsion units 20 as illustrated by the counter-rotative blade sets illustrated in the Figures.

A landing gear set of powered wheels 100 and caster wheels 110, illustrated in FIG. 2, extend below the bottom plane of said fuselage 30 and provides mobility on the ground through differential or collective turning of said powered wheels 100. The height of said powered wheels 100 and caster wheels 110 in conjunction with said fuselage 30 and with stowed said rotor propulsion units 20 determines the overall height of the stowed configuration.

In the process of unfolding from the stowed condition to the operating condition, if more than two rotor propulsion units 20 are utilized, the forward-most and rearward-most units deploy first until substantially perpendicular to the longitudinal axis of said fuselage 30, as illustrated in FIGS. 4 and 5. Then progressively towards the inner units there is space for each to rotate in a sequence of movements to avoid interference while unfolding. Rotation is generated internally with bearings and actuators of which there are numerous types known to those skilled in the art.

After horizontal deployment of all said rotor propulsion units 20, the VTOL aircraft may operate in the configuration illustrated in FIG. 5 as a multi-rotor copter with vertical and horizontal motion controlled through varying speed and power of said rotor propulsion units 20. Operated in this manner, the preferred embodiment of said horizontal support member 80 is substantially axisymmetric because the pitch trim of said VTOL aircraft 10 will vary with variations in speed and acceleration.

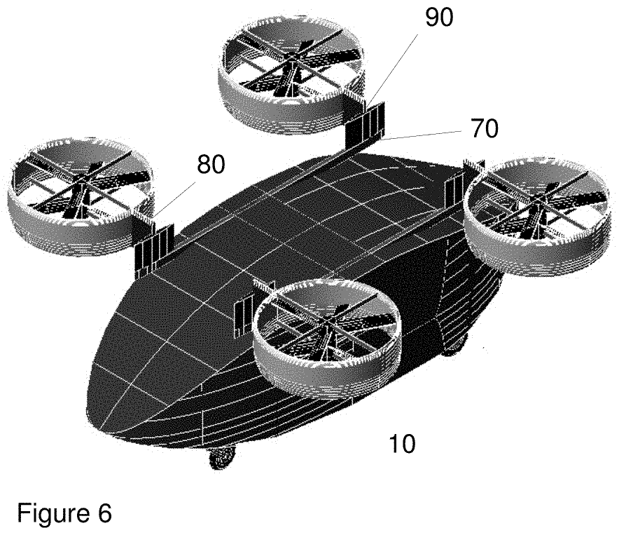

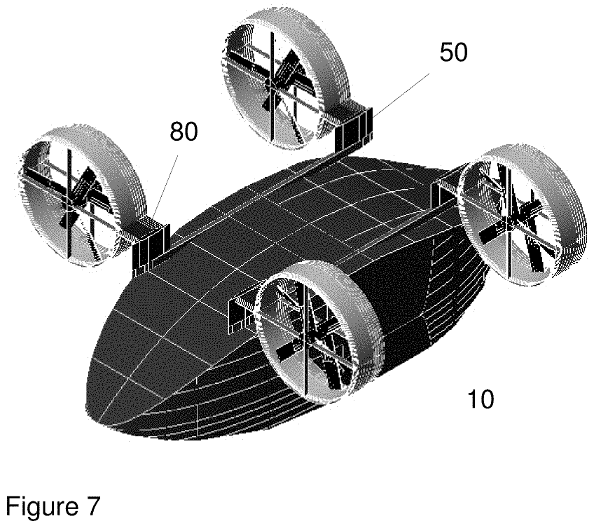

In an embodiment, said horizontal support members 80 may then tilt about the horizontal axis about a horizontal support pivot bearing 90 to form a tilt-rotor copter as illustrated in FIGS. 6 and 7. Operated in this manner, the preferred embodiment of said horizontal support member 80 is substantially a foil shape to aid in lift and to reduce drag because the pitch trim of said VTOL aircraft 10 will be substantially level in flight.

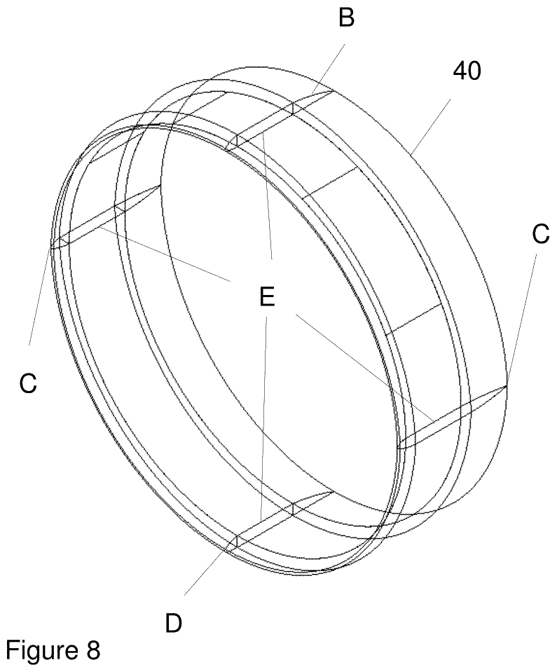

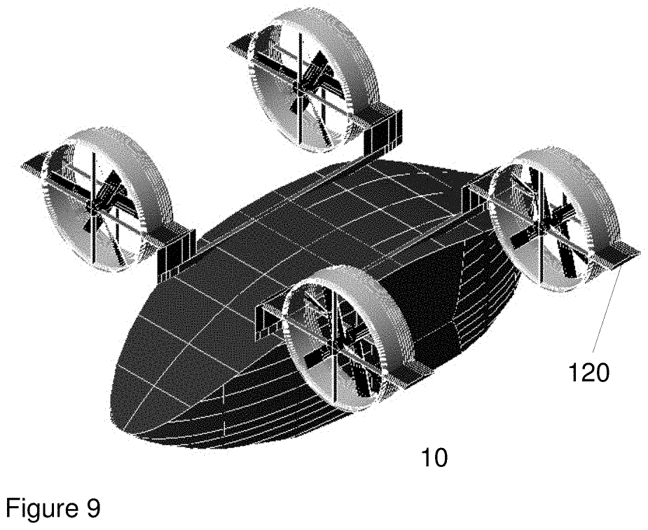

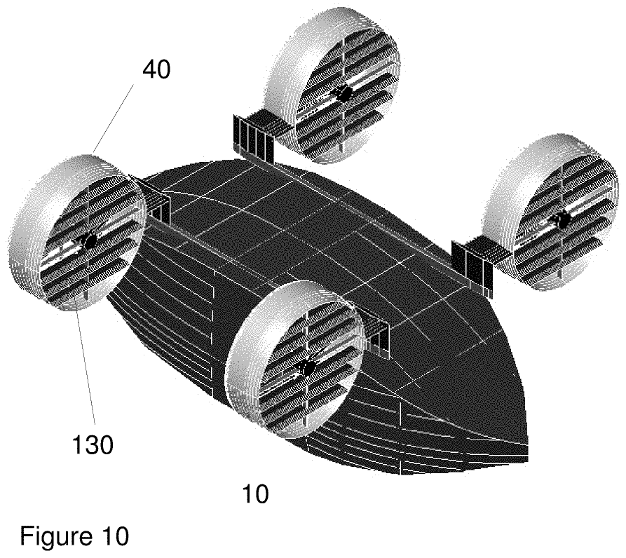

Said fuselage 30 is generally shaped to minimize propulsion module slipstream interaction during takeoff and landing while minimizing drag and producing lift at forward speed. In the tilt-rotor copter embodiment, duct 40 is shaped to produce extra lift over a simple axisymmetric shape by utilizing a circumferentially varying cross-sectional shape from top to bottom, as illustrated in FIG. 8. Said duct 40 has an internal cylindrical surface E that forms the surface adjacent to the swept rotor blade tips. Lift in the vertical plane to support said VTOL Aircraft 10 in flight is desireable; therefore, the top duct cross-section B and bottom duct cross-section D consists of a airfoil shapes to generate lift both parallel to airflow and when tilted to an angle of attack. Lift in the horizontal plane is not desireable as it would serve no useful purpose and add corresponding drag. Therefore, side duct cross-sections C have an axisymmetric shape to reduce drag. The complete shape of said duct 40 is a lofting of these cross-sections about said cylindrical surface E. Lift produced by said fuselage 30 and said ducts 40 allow greater range and payload for a VTOL aerial vehicle compared to the embodiment where propulsion is by said rotor propulsion units 20 alone. Lift combined with said power wheels 100 and caster wheels 110 allows the option for conventional take-offs and landings in a Short Takeoff mode and allows emergency landings like a conventional aircraft. Said power wheels 100 may assist with thrust during takeoff and, if electric, with regenerative braking during landing. In an embodiment, lift of said ducts 40 may be augmented by duct winglets 120, as illustrated in FIG. 9. In an embodiment, lift of said ducts 40 may be augmented by duct exit lift slats 130, as illustrated in FIG. 10. Said duct exit slats 130 also provide some degree of protection to persons on the ground from direct exposure to said rotor propulsion units 20 when descending vertically a landing location.

1. A folding multi-rotor vertical takeoff and landing aircraft comprising:
a fuselage lifted and propelled by multiple rotors; whereby,
rotors are stowed on a vertical axis above said fuselage substantially in a line along the longitudinal axis and are of geometry to fit in plan within the fuselage footprint; whereby,
said rotors are attached to said fuselage by vertical support members connected to horizontal support members; whereby,
said stowed rotors are deployed substantially in a horizontal plane to the operating condition by rotating said vertical support members; whereby,
once rotated the aircraft may operate in this configuration as a multi-rotor copter where altitude, attitude and speed are controlled strictly by motor power and speed; whereby,
said deployed propulsors may also tilt by rotation of said horizontal support members to form a tilt-rotor configuration for improving the forward speed and level flying attitude.

2. The folding multi-rotor vertical takeoff and landing aircraft of claim 1 wherein,
said rotor propulsion units may have a duct surrounding the rotors of unique airfoil shape with additional winglet and exit slat enhancements to provide lift, improved safety, and reduced noise.

3. The folding multi-rotor vertical takeoff and landing aircraft of claim 1 wherein,
said fuselage may have a landing gear system incorporating independently powered wheels in combination with steered and castered wheels to provide mobility into and out of stowage and provide emergency and short take-off and landing capabilities.
